(19) United States
(12) Patent Application Publication
(10) Pub. No.: US 2021/0112896 A1
(43) Pub. Date: Apr. 22, 2021

(54) Thermal Insulation Packages

(71) Applicant: W.L. Gore & Associates, Inc., Newark, DE (US)

(72) Inventor: Robert W. Gore, Newark, DE (US)

(21) Appl. No.: 16/464,398

(22) PCT Filed: Oct. 25, 2017
(86) PCT No.: PCT/US2017/058262

§ 371 Date: May 28, 2019

Related U.S. Application Data
(60) Provisional application No. 62/428,157, filed on Nov. 30, 2016.

(51) Int. Cl. A41D 31/102; A41D 31/06

(52) U.S. Cl. CPC A41D 31/102; B32B 27/322; A41D 31/065

(57) ABSTRACT

Thermal insulation packages (10) that are porous, air permeable, waterproof water vapor permeable, durable, and conformable are provided. The insulation packages include an insulation material (40) that is fully encompassed by at least one expanded polytetrafluoroethylene (ePTFE) membrane (20, 30). Two or more thermal insulation packages may be interconnected by sealed regions (50) to form an insulation construct. The thermal insulation packages and constructs may be used as inserts for garments or other articles.

### FIELD

The present disclosure relates generally to insulated articles (e.g., garments), and more specifically, to thermal insulation packages that are waterproof, air permeable, porous, durable, and conformable.

### BACKGROUND

Insulated garments are well-known and are typically worn by individuals in situations in which the individual may be exposed to cold and/or wet conditions. To provide warmth, these garments are filled with insulation. Typical insulations include down, a natural insulator, or man-made fibrous materials, such as Thinsulate® or PrimaLoft®.

A common method for inserting insulation materials into garments involves filling the garments with loose insulating material. For example, winter coats filled with down or fibrous insulation throughout the body portion and sleeves are well-known. These garments are usually constructed by covering and containing the insulation with woven or knitted textile fabrics. Such insulated garments are suitable for activities in dry conditions. However, in wet conditions, such as rain or melting snow, water may penetrate into the insulation in conventional garments through the needle holes of sewn seams or through the woven or knitted fabric itself. Even small amounts of water detract greatly from the thermal resistive properties of the insulation and add weight to the insulation, and therefore to the garment itself. Restoring the wet insulation by drying is difficult in cold environmental conditions and makes such garments unsuitable for prolonged outdoor exposure.

Another historical approach to keeping thermal insulation dry during wet conditions has been to replace the water permeable textile fabrics with impenetrable plastic materials. With this approach, constructing seams that are water impenetrable is still problematic. This problem is often overcome by heat sealing seams or with the use of adhesives rather than by sewing. A further problem exists with air impenetrable coverings for garment insulation, such as when a bulky insulated garment needs to be compressed for storage and the void air spaces within the insulation need to be exhausted. Such compression is greatly hindered by the air impenetrable nature of plastic covering materials. Other instances of the need for air exhaustion occur during normal athletic activities where impacts occur, such as when the wearer falls to the ground. The impact greatly increases the pressure within the encapsulated insulation space since there is no relief for air to escape. Thus, with impenetrable covering materials, such impacts often result in bursting of the seams or bursting of the air impermeable material itself.

Therefore an objective of this invention to provide thermal insulation packages that are waterproof, durable in use, air permeable, and highly conformable. Another purpose is to provide versatile, simple processes and guidelines for accomplishing this end result.

### SUMMARY

The invention relates to a thermal insulation package that includes a flexible, porous, air permeable, waterproof membrane enclosure that contains therein a thermal insulation material. In one or more embodiment, the membrane enclosure is formed of one or more expanded polytetrafluoroethylene (ePTFE) membranes. The expanded polytetrafluoroethylene membranes may be the same or different. The insulation material is fully encompassed by the ePTFE membrane(s). At least one of the ePTFE membranes is air permeable to permit air to be expelled from the encapsulated insulation. The thermal insulation package may include a sealed region that surrounds the insulation in the insulation package. Sealed regions allow penetration, such as by a needle, without compromising the insulation package. Thus, the insulation package remains intact and dry. Numerous insulation packages may be interconnected by sealed regions to form an insulation construct. The thermal insulation packages and constructs described herein may be used as inserts for garments or other articles, especially where there is a high susceptibility of the article becoming wet.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1A is schematic illustration depicting a cross-sectional view of a thermal insulation package utilizing two expanded polytetrafluoroethylene membranes according to at least one exemplary embodiment;

FIG. 1B is a schematic illustration depicting a perspective view of a thermal insulation package utilizing two expanded polytetrafluoroethylene membranes according to at least one exemplary embodiment;

FIG. 2 is a schematic illustration depicting a cross-sectional view of a thermal insulation construct including three thermal insulation packages in accordance with at least one exemplary embodiment;

FIG. 3 is a schematic illustration depicting a perspective view of a thermal insulation construct including three thermal insulation packages according to at least one exemplary embodiment;

FIG. 4A is a schematic illustration depicting a perspective view of a thermal insulation package utilizing one expanded polytetrafluoroethylene membrane in accordance with at least one exemplary embodiment;

FIG. 4B is a schematic illustration depicting the top view of the formation of the thermal insulation package of FIG. 4A in accordance with at least one exemplary embodiment;

FIG. 5A is a schematic illustration depicting a perspective view of a thermal insulation package utilizing one expanded polytetrafluoroethylene membrane in accordance with at least one exemplary embodiment; and

FIG. 5B is a schematic illustration depicting the top view of the formation of the thermal insulation package of FIG. 5A in accordance with at least one exemplary embodiment.

### DETAILED DESCRIPTION

Persons skilled in the art will readily appreciate that various aspects of the present disclosure can be realized by any number of methods and apparatus configured to perform the intended functions. It should also be noted that the accompanying figures referred to herein are not necessarily drawn to scale, but may be exaggerated to illustrate various aspects of the present disclosure, and in that regard, the drawing figures should not be construed as limiting.

The present invention relates to thermal insulation packages that are porous, air permeable, waterproof, durable, and flexible. The insulation packages include an insulation material that is fully encompassed by at least one expanded polytetrafluoroethylene (ePTFE) membrane. The expanded polytetrafluoroethylene membranes may be adhered or otherwise bonded about the periphery of the insulation material to create a watertight seal. The thermal insulation packages described herein may be used as inserts for garments or other articles, particularly where there is a high susceptibility of the article becoming wet.

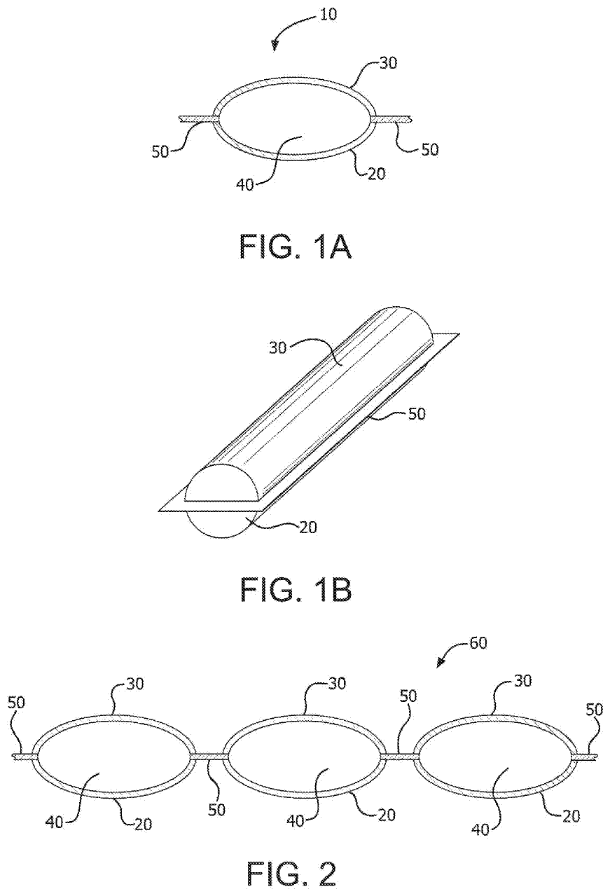

The flexible, porous, air permeable waterproof membranes described herein, are, for ease of discussion, described to be expanded polytetrafluoroethylene membranes. However, this disclosure is not to be considered limiting as other flexible, porous, air permeable waterproof membranes, such as those described below, may be used. Turning to FIGS. 1A and 1B, a thermal insulation package 10 may be formed of a first expanded polytetrafluoroethylene membrane 20, a second expanded polytetrafluoroethylene membrane 30, and an insulation material 40 positioned between and encompassed by the first and second expanded polytetrafluoroethylene membranes 20, 30. At least one of the expanded polytetrafluoroethylene membranes 20, 30 is air permeable to permit air to be expelled from the encapsulated insulation 40. In the embodiment depicted in FIGS. 1A and 1B, the first and second expanded polytetrafluoroethylene membranes 20, 30 are joined around the periphery of the insulation 40 to form sealed regions 50 which provide a watertight seal. Any suitable process for joining the expanded polytetrafluoroethylene membranes 20, 30 may be used provided that a waterproof seal is formed.

The porous nature of the expanded polytetrafluoroethylene membranes 20, 30 permits the use of common waterproof adhesives to bond the ePTFE membranes 20, 30 together. Thus, as one example, a waterproof pressure sensitive adhesive may be applied to a side of one or both of the expanded polytetrafluoroethylene membranes 20, 30 to form the sealed regions 50. The waterproof adhesive may be applied to the ePTFE layer(s) continuously or discontinuously (e.g., pattern printing). Alternatively, the first and second expanded polytetrafluoroethylene membranes 20, 30 may be bonded together (such as by fusion bonding or welding) to form the sealed regions 50. In exemplary embodiments, the sealed regions 50 have a sufficient margin to allow penetration (such as by a needle) without also penetrating the ePTFE membrane(s) encompassing the insulation 40 in the insulation package 10. In some embodiments, the sealed regions 50 extend from the insulation package 10 a distance of about 2 inches (approximately 51 mm), about 1.5 inches (approximately 38 mm), about 1 inch (approximately 25 mm), about 0.75 inches (approximately 19 mm), about 0.5 inches (approximately 12.7 mm), or about 0.25 inches (approximately 6.4 mm) or less. Additionally, the sealed regions 50 are highly flexible, lending to the overall conformability of the insulation package 10.

In other embodiments, a needle may pass through the insulation package 10, such as, for example, to form sub-packages or designs within the insulation package 10 with minimal to no water ingress. It is to be appreciated that the insulation packages described herein may be sewn in the sealed region(s), sewn in the insulation package(s) 10, or sewn in both the sealed region(s) and the insulation package(s) and permit little or no water infiltration into the insulation package 10. As one example, a garment or other article may include a plurality of insulation packages where one or more of the insulation packages includes a “stitch line” such as from stitching the article together or to make an aesthetically pleasing surface. As used herein, the term “stitch line” is meant to encompass a seam or where a needle or other sharp object has passed through the insulation package in a linear or non-linear manner.

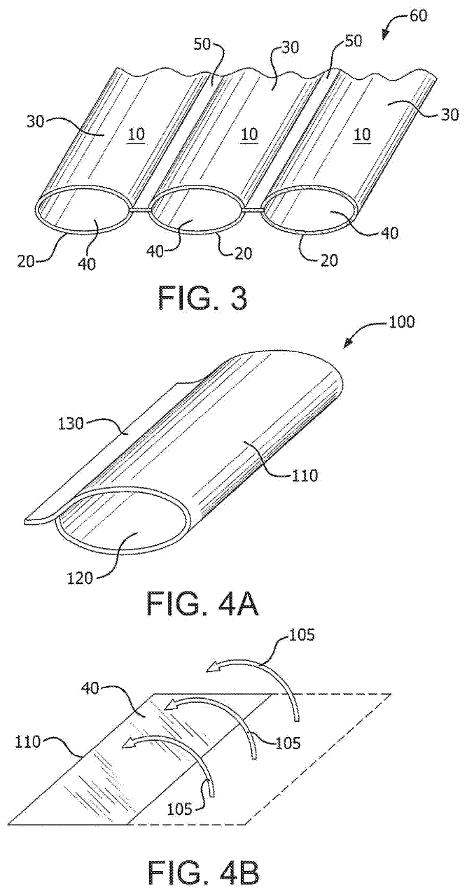

As shown in FIGS. 2 and 3, more than one thermal insulation package 10 may be interconnected by sealed regions 50 to form an insulation construct 60. It is to be appreciated that although FIGS. 2 and 3 depict three insulation packages 10 within the insulation construct 60, fewer or more insulation packages 10 may be included depending on the intended use and/or final placement of the insulation construct 60. The insulation construct 60 may be formed by placing a desired amount of insulation 40 on the first expanded polytetrafluoroethylene membrane 20 and positioning the second expanded polytetrafluoroethylene membrane 30 on top of the insulation 40 and the first expanded polytetrafluoroethylene membrane 20. If an adhesive is used to bond the first and second ePTFE membranes 20, 30, it should be applied prior to and/or after the insulation 40 is placed on the first ePTFE membrane 20 and before the second ePTFE membrane 30 is positioned on top of the first ePTFE membrane 20. The sealed regions 50 extending between the insulation packages 10 may have a width of about 2 inches (approximately 51 mm), about 1.5 inches (approximately 38 mm), about 1 inch (approximately 25 mm), about 0.75 inches (approximately 19 mm), about 0.5 inches (approximately 12.7 mm), or about 0.25 inches (approximately 6.4 mm), or less.

In some embodiments, a thermal insulation package 100 may be formed of a single expanded polytetrafluoroethylene membrane 110 wrapped about the insulation 40 and sealed at sealed region 130, such as is depicted in FIG. 4A. To form the thermal insulation package 100, a waterproof adhesive may be applied to one side of the ePTFE membrane 110 prior to positioning the insulation 40 on a portion of the adhesive side of the ePTFE membrane 100. Next, as depicted in FIG. 4B, the portion of the ePTFE membrane 110 having no insulation 40 thereon may be brought over (e.g., folded over) the insulation 40 as indicated by arrows 105 to bring the two ends of the ePTFE membrane 110 together at the sealed region 130. It is to be appreciated that, although not depicted, the sealed region 130 extends around three sides of the insulation package so as to fully encompass the insulation 40. Pressure applied to the sealed region 130 provides a strong, watertight seal. In exemplary embodiments, the sealed region 130 has a sufficient margin to allow penetration (such as by a needle) without also penetrating ePTFE membrane 110 encapsulating the insulation 40 in the insulation package 100. In some embodiments, the sealed region 130 extends from the insulation product 100 a distance of about 2 inches (approximately 51 mm), about 1.5 inches (approximately 38 mm), about 1 inch (approximately 25 mm), about 0.75 inches (approximately 19 mm), about 0.5 inches (approximately 12.7 mm), or about 0.25 inches (approximately 6.4 mm) or less. Additionally, the sealed region 130 is highly flexible, lending to the overall conformability of the insulation package 100.

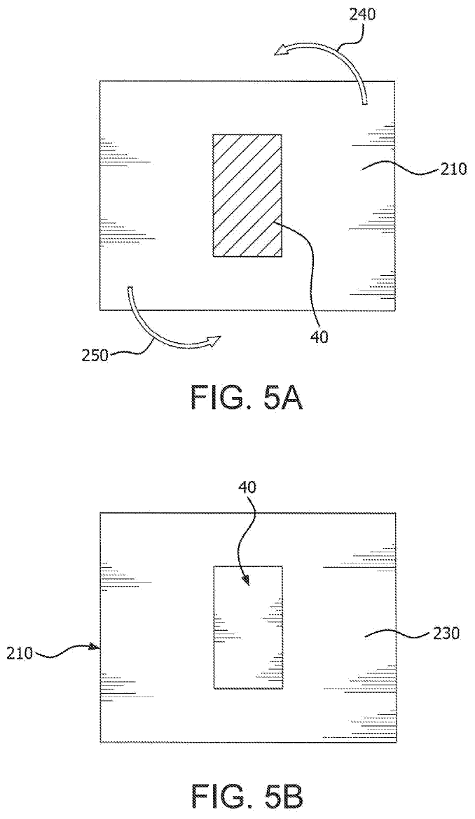

In exemplary embodiments, a thermal insulation package 200 may be formed of a single expanded polytetrafluoroethylene membrane 210 that is folded upon itself in a manner so as to encapsulate the thermal insulation 40 and form a sealed region 230 around the periphery thereof, such as is depicted in FIGS. 5A and 5B. To form the insulation package 200, a waterproof adhesive may be applied to the ePTFE membrane 210 prior to and/or after the insulation material 40 is substantially centrally located on the expanded polytetrafluoroethylene membrane 210. As shown in FIG. 5A, a first side of the ePTFE membrane 210 is folded over the insulation material 40 as depicted by arrow 240. A second side of the ePTFE membrane 210 is then folded over the first side of the ePTFE membrane 210 (and the insulation material 40) as indicated by arrow 250. The first and second sides of the expanded polytetrafluoroethylene membrane 210 are folded over the insulation material 40 in a manner such that a sealed region 230 surrounds the insulation material 40, as shown in FIG. 5B. Pressure applied to the sealed region 230 provides a strong, watertight seal. In some embodiments, the sealed region 230 extends from the insulation material 40 a distance of about 2 inches (approximately 51 mm), about 1.5 inches (approximately 38 mm), about 1 inch (approximately 25 mm), about 0.75 inches (approximately 19 mm), about 0.5 inches (approximately 12.7 mm), or about 0.25 inches (approximately 6.4 mm), or less, providing a margin that allows penetration (such as by a needle) without also penetrating the ePTFE membrane 210 encapsulating the insulation 40 in the insulation package 200. It is to be appreciated that the sealed region 230 may or may not extend the same distance around the insulation 40 depending upon how the first and second sides of the expanded polytetrafluoroethylene membrane 210 are folded over the insulation material 40.

The type of insulation 40 within the thermal insulation package and insulation construct is not particularly limited so long as the insulation is air permeable. Non-limiting examples of insulation suitable for use as the insulation material 40 include fibrous batting materials (e.g. PrimaLoft®), down, and/or polyester thermal insulation.

It is to be appreciated that with respect to the ePTFE membranes in the thermal insulation packages and constructs, reference is made herein with respect to expanded polytetrafluorethylene membranes made in accordance with the teachings of U.S. Pat. No. 3,953,566 to Gore for ease of discussion. However, it is to be understood that any suitable flexible, porous, air permeable, and waterproof fluoropolymer may be used interchangeably with the ePTFE membranes described within this application. Non-limiting examples of such fluoropolymers include, but are not limited to, expanded PTFE and blends thereof, expanded modified PTFE, and expanded copolymers of PTFE. Patents covering expandable blends of PTFE, expandable modified PTFE, and expanded copolymers of PTFE include, but are not limited to, U.S. Pat. No. 5,708,044 to Branca; U.S. Pat. No. 6,541,589 to Baillie; U.S. Pat. No. 7,531,611 to Sabol et al.; U.S. Pat. No. 8,637,144 to Ford; and U.S. Pat. No. 9,139,669 to Xu et al.

Other membranes may be utilized with, or in place of, the ePTFE membranes described herein. For instance, non-fluoropolymer polymeric materials such as, but not limited to, polyolefins (e.g., polypropylene and polyethylene), polyurethanes, and polyesters are considered to be within the purview of the invention provided that the polymeric material can be processed (e.g. to enhance hydrophobicity) to form flexible, porous, air permeable, and waterproof membrane structures. It is desirable that any waterproofing material or process that may be used, such as, for example, on the non-fluoropolymer polymeric materials not alter the desirable properties of the insulation 40, such as softness, loft, and conformability and do not add undesirable properties such as noise when flexed.

It is also to be appreciated that some or all of the expanded polytetrafluoroethylene membranes and/or non-fluoropolymer polymeric membranes may vary in composition, thickness, permeability, etc. from each other within the insulation package or construct. In other words, the membranes need not be identical in the insulation package or construct. However, it is to be appreciated that at least one of the membranes in the insulation package or construct needs to be air permeable (and both membranes need to be waterproof). Additionally, the ePTFE membranes may be loosely draped over the thermal insulation (e.g., “oversized”) to improve impact resistance of the thermal insulation package or construct.

Due to the hydrophobic molecular structure of polytetrafluoroethylene, the insulation package is permeable to air yet impermeable to water. Air permeability permits air to flow through the membrane so that the fully encapsulated insulation may be compressed without bursting or otherwise creating a defect (e.g., a hole or tear) in the insulation package. The insulation package, when inserted in a garment for example, may be subjected to physical forces that cause significant changes in the insulation volume, causing air to be expelled from voids in the insulation material. Such physical force on the insulation package may be due, for example, to a person falling, when a person is engaged in physical sports, or when the garment is compressed to be packed and/or stored.

The expanded polytetrafluoroethylene membrane(s) also restrict the entry of water into the thermal insulation. Waterproofness of the insulation package is desirable because even a small amount of water (or other liquid) intruding into the thermal insulation significantly decreases the thermal insulating properties of the insulation and permits for thermal conductivity of the temperature of the water (or other liquid) through the garment. Such thermal conductivity may be detrimental in cases where the wearer is in a cold environment and the cold is transported to the body of the wearer. Additional concerns of water ingress include an increase of weight due to the water pick-up and the difficulty of drying significant amounts of water from the wet insulation.

Persons skilled in the art will readily appreciate that various aspects of the present disclosure can be realized by any number of methods and apparatus configured to perform the intended functions. It should also be noted that the accompanying figures referred to herein are not necessarily drawn to scale, but may be exaggerated to illustrate various aspects of the present disclosure, and in that regard, the figures should not be construed as limiting.

### EXAMPLES

### Example 1—Insulation Package Formed with Single ePTFE Membrane

An expanded polytetrafluoroethylene membrane (part number 1057288, W.L. Gore & Associates, Inc., Elkton, Md.) was sprayed on the top side thereof with a pressure sensitive adhesive (3M Super 77 Spray Adhesive). Polyester thermal insulation (Mountain Mist polyester batting), 1 inch (approximately 25.4 mm) thick, was cut to form a sample having a 23 inch (approximately 58.4 cm) width and an 18 inch (approximately 45.7 cm) length. The thermal insulation sample was positioned on the adhesive side of the ePTFE membrane. The remaining portion of the ePTFE membrane was brought over the insulation to cover the upper side of the insulation, bringing the two sides of the ePTFE membrane together. Slight pressure was applied to the seal to provide a strong bond of the two adhesive coated surfaces. The final result was a thermal insulation package.

The thermal insulation package containing the fully encapsulated insulation was fully immersed in water and manually manipulated without water intrusion into the insulation package and the insulation package did not burst. It was also noted that when the insulation package was removed from the water, it was in its original dry condition.

### Example 2—Insulation Package Formed with Single ePTFE Membrane

An expanded polytetrafluoroethylene membrane (part number 1057288, W.L. Gore & Associates, Inc., Elkton, Md.) was sprayed on one side thereof with a pressure sensitive adhesive (3M Super 77 Spray Adhesive) in substantially parallel strips. An 8 inch×8 inch (approximately 20.3 cm×20.3 cm) sample of a fibrous polyester batting insulation material was centrally placed on the adhesive on the ePTFE membrane. One side of the ePTFE membrane was folded over the insulation material to cover the insulation material. Next, the second side of the ePTFE membrane was folded over the ePTFE membrane covering the insulation material such that an approximate 2 inch (approximately 51 mm) margin surrounded the insulation material. The ePTFE membrane surrounding the 8 inch×8 inch (approximately 20.3 cm×20.3 cm) sample of insulation material were pressed together to form a watertight seal. The adhesive was permitted to dry overnight.

The resultant insulation package was tested for percent water pick-up in accordance with a modified FED-STD 191 Method 5502. The insulation package was weighed and the weight was recorded. The insulation package was then immersed in water for 20 minutes. The insulation package was removed from the water and shaken one time. The weight of the shaken insulation package was recorded. Next, the insulation package was blotted between two pieces of blotter paper and re-weighed. The weight of the blotted insulation package was recorded. The percent water pick-up was calculated as follows:

Water Pick-up (%)=(Final Wet Specimen Weight−Initial Specimen Weight)/Initial Specimen Weight×100.

The percent water pick-up of the insulation package was determined to be 5.43%. It was concluded that nearly all the water in this example is surface water and that water did not penetrate into the insulation. The results are set forth in Table 1.

TABLE 1
Insulation Package

| | | | Water Pick-Up |
|---|---|---|---|
| | Weight | Weight Gain | (as % of |
| Condition | (g) | (g) | initial weight) |
| Initial | 18.43 | | |
| After 20 minute | 23.12 | 4.69 | 25.45 |
| immersion | | | |
| After 1 Shake | 20.55 | 2.12 | 11.5 |
| After Blotter | 19.43 | 1.00 | 5.43 |

In addition, the air permeability of the insulation package was determined according to FED-STD-191A Method 5452. The air permeability was determined to be 36.74 seconds.

The insulation package was then punctured one time with standard, commercially available thumbtack to create a small hole in the insulation package. The punctured insulation package was subjected to the same percent water pick-up test procedure set forth above. The results are shown in Table 2. The percent water pick-up of the punctured insulation package was determined to be 3.32%. It was concluded from this example that even a small puncture does not allow significant water ingress into the insulation package.

TABLE 2
Insulation Package with Puncture

| | | | Water Pick-Up |
|---|---|---|---|
| | Weight | Weight Gain | (as % of |
| Condition | (g) | (g) | initial weight) |
| Initial | 18.37 | | |
| After 20 minute | 24.83 | 6.46 | 35.16 |
| immersion | | | |
| After 1 Shake | 21.25 | 2.88 | 15.68 |
| After Blotter | 18.98 | 0.61 | 3.32 |

Next, the insulation was removed from the insulation package and was subjected to the same percent water pick-up test procedure set forth above. The percent water pick-up of the insulation was determined to be 63.76%. The results are shown in Table 3.

TABLE 3
Insulation Only

| | | | Water Pick-Up |
|---|---|---|---|
| | Weight | Weight Gain | (as % of |
| Condition | (g) | (g) | initial weight) |
| Initial | 5.96 | | |
| After 20 minute | 29.43 | 23.47 | 393.79 |
| immersion | | | |
| After 1 Shake | 23.69 | 17.73 | 297.48 |
| After Blotter | 9.76 | 3.8 | 63.76 |

This example illustrates that the insulation itself picks up a significant amount of water when not protected by the membrane.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

1-10. (canceled)

11. A thermal insulation package comprising:
a first porous polymer membrane layer;
a second porous polymer membrane layer;
a thermal insulation material positioned between and encapsulated by said first and second porous polymer membrane layers; and
a waterproof sealed region surrounding said thermal insulation material.

12. The thermal insulation package of claim 11, wherein said first and second porous polymer layers comprise expanded polytetrafluoroethylene membranes.

13. The thermal insulation package of claim 11, wherein at least one of said first and second porous polymer membrane layers comprise an expanded polytetrafluoroethylene membrane.

14. The thermal insulation package of claim 11, wherein said thermal insulation package has an air permeability of at least 37 seconds.

15. A thermal insulation package comprising:
at least one porous air permeable polymer membrane encapsulating a thermal insulation material; and
a waterproof sealed region on a side of said porous air permeable polymer membrane.

16. The thermal insulation package of claim 15, wherein said at least one polymer membrane comprises an expanded polytetrafluoroethylene membrane.

17. The thermal insulation package of claim 15, wherein said thermal insulation package has an air permeability of at least 37 seconds.

18. An insulation construct comprising a plurality of said thermal insulation packages claimed in claim 11.

19. An insulation construct comprising a plurality of said thermal insulation packages claimed in claim 15.

20. A garment comprising:
at least one insulation package, said insulation package including:
a first porous polymer membrane layer;
a second porous polymer membrane layer;
a thermal insulation material positioned between and encapsulated by said first and second porous polymer membrane layers; and
a waterproof sealed region surrounding said thermal insulation material,
wherein said at least one insulation package further comprises a stitch line, and
wherein the at least one insulation package is present in the garment as an insert.

21. The thermal insulation package of claim 20, wherein said first and second porous polymer layers comprise expanded polytetrafluoroethylene membranes.

22. The thermal insulation package of claim 20, wherein at least one of said first and second porous polymer membrane layers comprises an expanded polytetrafluoroethylene membrane.

23. A garment comprising:
at least one thermal insulation package, said thermal insulation package including:
a first porous polymer membrane layer;
a second porous polymer membrane layer;
a thermal insulation material positioned between and encapsulated by said first and second porous polymer membrane layers; and
a waterproof sealed region surrounding said thermal insulation material,
wherein said at least one insulation package further comprises a stitch line, and
wherein the at least one thermal insulation package is present in the garment as an insert.

24. The thermal insulation package of claim 23, wherein said first and second porous polymer layers comprise expanded polytetrafluoroethylene membranes.

25. The thermal insulation package of claim 23, wherein at least one of said first and second porous polymer membrane layers comprise an expanded polytetrafluoroethylene membrane.

26. The thermal insulation package of claim 11 wherein the waterproof sealed region is free from insulation.

27. The thermal insulation package of claim 11, wherein the thermal insulation package is an insulation construct comprising more than one thermal insulation packages interconnected by waterproof sealed regions.

28. The thermal insulation package of claim 26, wherein the thermal insulation package is an insulation construct comprising more than one thermal insulation packages interconnected by waterproof sealed regions.

29. The garment of claim 20, wherein the stitch line is present in the waterproof sealed region.

30. The garment of claim 23, wherein the stitch line is present in the waterproof sealed region.
